(19) United States
(12) Patent Application Publication
(10) Pub. No.: US 2010/0250420 A1
(43) Pub. Date: Sep. 30, 2010

(54) SYSTEMS AND METHODS FOR BUDGET GUARDRAILS

(75) Inventors: Kazi M. Ariff, Quincy, MA (US); Carol A. Smith, Edgartown, MA (US); Shane A. Johnson, Charlotte, NC (US); Russell W. Tipper, Boston, MA (US); Yicong Li, Lexington, MA (US); Sean M. O'Connor, Scituate, MA (US); Thomas D. Kelley, Hingham, MA (US); Susan S. Thomas, Gastonia, NC (US); William F. Borowski, Millbury, MA (US); William J. Aheron, Charlotte, NC (US); Judith M. Anderson, East Walpole, MA (US); Steven K. Hayes, Bemus Point, NY (US); Neal G. Wolfson, Lexington, MA (US); Jeffrey P. Judd, Boston, MA (US); James P. Kirkman, Acton, MA (US); Jeffrey H. Bierer, Charlotte, NC (US)

Correspondence Address: MOORE & VAN ALLEN, PLLC FOR BOFA, 430 DAVIS DRIVE, SUITE 500, POST OFFICE BOX 13706, RESEARCH TRIANGLE PARK, NC, 27709, US

(73) Assignee: BANK OF AMERICA CORPORATION, Charlotte, NC (US)

(21) Appl. No.: 12/414,433

(22) Filed: Mar. 30, 2009

(51) Int. Cl. G06Q 40/00

(52) U.S. Cl. 705/35

(57) ABSTRACT

Systems, methods, and computer program products are provided for user-configured spending guardrails in a budget tracking system. The use of spending guardrails is instrumental in insuring that the user of the budget tracking system adheres to their assigned budget. By providing for dynamically configurable spending thresholds the user may define, change, suspend or the like spending guardrails as dictated by current circumstances. The configurable nature of the guardrails insures that guardrails are tailored to the needs of the individual user.

### REFERENCE TO CO-PENDING APPLICATIONS FOR PATENT

The present Application for Patent is related to the following co-pending United States Patent Applications:

“Systems and Methods for Determining Target Budget Allocation”, inventors Ariff et al., having an Attorney Docket No. 014033.000497, filed concurrently herewith, assigned to the assignee hereof, and expressly incorporated by reference herein

“Systems and Methods for Determining a Financial Health Indicator”, inventors Ariff et al., having an Attorney Docket No. 014033.000558, filed concurrently herewith, assigned to the assignee hereof, and expressly incorporated by reference herein; and

“Systems and Methods for Determining the Budget Impact of Purchases, Potential Purchases and Cost Adjustments”, inventors Ariff et al., having an Attorney Docket No. 014033.000559, filed concurrently herewith, assigned to the assignee hereof, and expressly incorporated by reference herein.

### FIELD

In general, embodiments herein disclosed relate to systems, methods, and computer program products for budget guardrails and, more specifically, user-configured budget guardrails that provide for a guardrail action, such as an alert, a penalty or the like to occur in the event that a budget guardrail is triggered.

### BACKGROUND

In general, most individuals have a difficult time saving money. This problem is evident in the United States where the national average personal savings rate has recently moved from the positive to the negative for the first time since the Great Depression, meaning Americans are spending more than they are saving. While statistics show that 78 million Americans will retire in the next 20 years, long-term financial planning and retirement goals for the vast majority of these individuals are cast in doubt by the inability to save.

Furthermore, problems associated with inadequate savings not only affect long-term retirement plans, but also come to the forefront during prolonged recessionary periods, such as the global recession currently being experienced. With individuals being displaced from their employment at alarming rates, these individuals need to call on their short-term savings as a means of support in the interim. In this regard, the need to address the savings problem takes on a sense of urgency.

However, admitting a savings problem and doing something about it are not one in the same. Saving money requires an individual to budget properly and, for whatever reason, be it unwillingness, inability or the like, individuals have shown a proven tendency not to budget properly. This problem is exasperated in a downturned economy in which a whole new sector of the population must accept at least a slight decrease, and in some instances a significant decrease, in their standard of living. Thus, the need to budget, and moreover budget effectively, becomes imperative.

Currently, many commercial applications exist that assist individuals with budgeting. For example, Microsoft® Money, available from Microsoft Corporation of Redmond, Wash. and Intuit® Quicken®, available from Intuit Incorporated of Mountain View, Calif. are two such commercially available budget applications. However, these applications may be limited in the data resources they have available to assess a user's current budget allocation and determine or make recommendations for a user's target budget allocation. Moreover, these applications may be limited in terms of the data resources they have available to automatically track an individual's spending, i.e., the individual's ability to stay on budget. In addition to possible data resource limitations, the corporations that provide these applications are not in the business of providing their users with financial planning and/or financial advice and, therefore, do not employ a staff dedicated to ensuring their users financial security. Therefore, when using these types of commercial budget applications, the user is on their own when it comes to making financial decisions that affect their budget, short-term savings and/or long-term savings.

Additionally, known budgeting applications do not possess the ability to ensure that users adhere to their assigned budgets. In this regard, the commercial entities that provide such applications are not in a position to reward and/or penalize users that are successful or fail to stay on budget. In addition, currently existing budgeting applications do not possess the ability to provide the user a comprehensive and dynamic financial health indicator that takes into account various factors that cumulatively affect the user's overall financial health.

In addition, current budgeting applications do not provide for a spending deterrence. In this regard, current budgeting applications do not assess the budget ramifications of proposed expenditures, recurring expenditures or cost adjustments to fixed expenditures, such as rent, house payment, automobile payment and the like.

Up until now, financial institutions have been focused on providing their customers with investment services, loan services and the like. However, by shifting the financial institution mindset from an investment strategy to a budget strategy, these institutions, such as banks and the like, can capitalize on an increase in customer assets (i.e., savings), an increase in customer retention, and lower the credit risk for their customer base. Additionally, financial institutions have the ability to leverage instrumental budget-related data that may be otherwise unavailable to other commercial entities providing budget applications.

Therefore, a need exists to develop systems, methods, apparatus, computer program products and the like for an improved budgeting system. In this regard, the budget system should improve upon the accuracy of the determination of the user's current budget allocation and provide for a more comprehensive and focused means for determining and/or recommending a target budget allocation to the user. In addition, desired systems, methods, apparatus, computer program products and the like should provide for a better means to ensure that the user stays on track in terms of their budget allocation and a means to reward and/or penalize the user if they do/do not stay on their budgeting track. Additionally, the desired systems, methods, apparatus, computer program products and the like should provide for a dynamic tool that indicates how well a user is doing in regards to meeting their budget, making improvements in savings and/or improving their overall creditworthiness. Moreover, the desired systems, methods, apparatus, computer program products and the like should provide for a spending deterrence that affectively limits the amount of spending incurred by the user, thereby further assisting the user in adhering to their respective target budget allocation.

### SUMMARY

The following presents a simplified summary of one or more embodiments in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments in a simplified form as a prelude to the more detailed description that is presented later.

Methods, systems and computer program products are defined that provide for user-configured spending guardrails to be implemented in conjunction with a comprehensive budget tracking system. The user of the budget tracking system may define one or more spending guardrails (i.e., spending thresholds) within one or more budget categories having one or more associated guardrail actions that occur when a budget guardrail is achieved. The user may set the guardrail at any desirable spending threshold, such as at the allocated target budget limit for a given budget category or below or above the allocated target budget limit. The guardrail actions, which may be system defined or user configured, may include, but are not limited to, guardrail alerts and/or guardrail penalties. Guardrail alerts are communications sent to the user to inform them that a guardrail has been met. Additionally, the user may configure the frequency at which the guardrails are communicated and the communication mechanism used to communicate the guardrails. Guardrail penalties may be self-imposed user penalties, such as an automated charitable contribution, an automated contribution to a designated user savings account or a ban on further expenditures in the category associated with the guardrail.

The use of spending guardrails is instrumental in insuring that the user of the budget tracking system adheres to their assigned budget. By providing for dynamically configurable spending thresholds the user may define, change, suspend or the like spending guardrails as dictated by current circumstances. The configurable nature of the guardrails insures that guardrails are tailored to the needs of the individual user.

A method for providing guardrail protection in a budget tracking system defines an embodiment of the invention. The method includes providing a target budget allocation for a plurality of budget categories and receiving one or more first user inputs that predefine, for at least one budget category, at least one budget guardrail having at least one associated budget guardrail action. The method further includes tracking expenditures for the plurality of budget categories, determining that a budget guardrail has been met and providing for the budget guardrail action associated with the budget guardrail based on determining that the guardrail has been met or based on determining that the guardrail is approaching being met. According to specific embodiments of the method, the budget guardrail may be defined as a budget threshold at or below the target budget allocation for the associated budget category.

According to other specific embodiments of the method, the budget guardrail action may be further defined as a guardrail alert. In such aspects, the method may further include receiving one or more second user inputs that predefine a communication mechanism for the guardrail alert. The communication mechanisms may include, but are not limited to, electronic mail (e-mail), Short Message Service (SMS), voice mail, an online budget application display or the like. Additionally, in such aspects the method may further include receiving one or more second user inputs that predefine a frequency of communication for the guardrail alert. For example, the user may configure the alert to be sent daily, weekly or the like or the user may configure the alert to be sent more frequently as expenditures approach the guardrail and/or the target allocation limit for the category.

According to other specific embodiments of the method, the budget guardrail action may be further defined as a guardrail penalty. A guardrail penalty may include, but is not limited to, an automatic charitable contribution, an automatic savings contribution, a limit on an amount of an expenditure in the associated budget category or a prohibition on an expenditure in the associated budget category.

In still further specific embodiments of the method, providing for a target budget allocation for a plurality of budget categories may further include determining a target budget allocation for the plurality of budget categories based on a current budget allocation and results of user-responsive budget profile questionnaire. Additionally, in such embodiments, the method may include receiving one or more user modifications to the determined target budget allocation. Alternatively, providing a target budget allocation for a plurality of budget categories may further include determining peer budget allocation data based on a user's profile, providing the peer budget allocation data to the user and receiving user selections for the target budget allocation based on the peer budget allocation data.

In other specific embodiments of the method, tracking expenditures for the plurality of budget categories may further include tracking, automatically, electronic expenditures based on a purchase type associated with a budget category and tracking, manually, based on user purchasing inputs to an online budget application. In this regard, purchases made with a credit/debit card or check may be tracked automatically while purchases made with cash may require the user to manually input the budget related data using an online budget application or a budget application otherwise accessible via a wireless device.

Another embodiment of the invention is provided for by an apparatus. The apparatus, which may include more than one device, includes a computing platform including at least one processor and a memory. The apparatus also includes a budget module stored in the memory, executable by the processor and operable to track expenditures for users. The budget module includes a budget user profile database that includes a plurality of budget user profiles, each profile including a plurality of budget categories. The budget categories include at least one user-configured budget guardrails and each guardrail includes at least one budget guardrail actions. The budget module additionally includes a budget tracking module operable to track expenditures for the plurality of budget categories, determine that a budget guardrail has been met or is approaching being met and provide for the budget guardrail action associated with the budget guardrail based on the determination that the budget guardrail has been met or based on determination that a budget guardrail is approaching being met. According to specific embodiments of the apparatus the budget guardrail is further defined as a budget threshold set at, below or above a target budget allocation for an associated budget category.

In certain specific embodiments of the apparatus, the budget guardrail action may be further defined as a guardrail alert. In such embodiments, the guardrail alert may further include a user-configured communication mechanism for communicating the guardrail alert. The communication mechanism may include, but is not limited to, electronic mail (e-mail), Short Message Service (SMS), voice mail, an online budget application display or the like. Additionally, in such embodiments, guardrail alert further comprises a user-configured frequency for communicating the guardrail alert. For example, the user may configure the alert to be sent daily, weekly or the like or the user may configure the alert to be sent more frequently as expenditures approach the guardrail and/or the target allocation limit for the category.

In other specific embodiments of the apparatus, the budget guardrail action may be further defined as a budget penalty. A guardrail penalty may include, but is not limited to, an automatic charitable contribution, an automatic savings contribution, a limit on an amount of an expenditure in the associated budget category or a prohibition on an expenditure in the associated budget category.

Yet another embodiment of the invention is defined by a computer program product that includes a computer-readable medium, The medium includes a first set of codes for causing a computer to provide a target budget allocation for a plurality of budget categories and a second set of codes for a causing a computer to receive one or more first user inputs that predefine, for at least one budget category, at least one budget guardrail having at least one associated budget guardrail action. The medium also includes a third set of codes for causing a computer to track expenditures for the plurality of budget categories, a fourth set of codes for causing a computer to determine that a budget guardrail has been met and a fifth set of codes for causing a computer to provide for the budget guardrail action associated with the budget guardrail.

Thus, methods, systems, computer program products and the like are described in detail herein, which provide for user-configured spending guardrails in a budget tracking system. The use of spending guardrails is instrumental in insuring that the user of the budget tracking system adheres to their assigned budget. By providing for dynamically configurable spending thresholds the user may define, change, suspend or the like spending guardrails as dictated by current circumstances. The configurable nature of the guardrails insures that guardrails are tailored to the needs of the individual user.

To the accomplishment of the foregoing and related ends, the one or more embodiments comprise the features hereinafter fully described and particularly pointed out in the claims. The following description and the annexed drawings set forth in detail certain illustrative features of the one or more embodiments. These features are indicative, however, of but a few of the various ways in which the principles of various embodiments may be employed, and this description is intended to include all such embodiments and their equivalents.

### BRIEF DESCRIPTION OF THE DRAWINGS

Having thus described embodiments of the invention in general terms, reference will now be made to the accompanying drawings, which are not necessarily drawn to scale, and wherein:

FIG. 1 is a block diagram depiction of a system for budget tracking, according to an embodiment of the present invention;

FIG. 2 is a block diagram depiction illustrating an apparatus configured to provide for user configuration of guardrails and tracking of guardrails in a budget tracking system, in accordance with embodiments of the present invention;

FIG. 3 is a more detailed block diagram of an apparatus configured for providing a budget tracking system, in accordance with an embodiment of the present invention;

FIG. 4 is a flow diagram detailing a method for determination and/or selection of a target budget allocation and associated budget guardrails, in accordance with present embodiments;

FIG. 5 is a flow diagram of a method for tracking budget expenditures and, in particular tracking user-defined budget guardrails, in accordance with present embodiments;

FIG. 6 is a flow diagram of a method for determining a financial health indicator, in accordance with present embodiments;

FIG. 7 is a flow diagram of a method for providing purchase impact determination in budget system, in accordance with an embodiment of the present invention; and

FIG. 8 is a flow diagram of a method for providing for and tracking budget guardrails, in accordance with yet another embodiment of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. In the following description, for purposes of explanation, numerous specific details are set forth in order to provide a thorough understanding of one or more embodiments. It may be evident however, that such embodiment(s) may be practiced without these specific details. Like numbers refer to like elements throughout.

Various embodiments or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

The steps and/or actions of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some embodiments, the processor and the storage medium may reside in an Application Specific Integrated Circuit (ASIC). In the alternative, the processor and the storage medium may reside as discrete components in a computing device. Additionally, in some embodiments, the events and/or actions of a method or algorithm may reside as one or any combination or set of codes and/or instructions on a machine-readable medium and/or computer-readable medium, which may be incorporated into a computer program product.

In one or more embodiments, the functions described may be implemented in hardware, software, firmware, or any combination thereof. If implemented in software, the functions may be stored or transmitted as one or more instructions or code on a computer-readable medium. Computer-readable media includes both computer storage media and communication media, including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures, and that can be accessed by a computer. Also, any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. “Disk” and “disc”, as used herein, include compact disc (CD), laser disc, optical disc, digital versatile disc (DVD), floppy disk and blu-ray disc where disks usually reproduce data magnetically, while discs usually reproduce data optically with lasers. Combinations of the above should also be included within the scope of computer-readable media.

Thus, methods, systems, computer programs and the like are herein disclosed that provide for user-configured spending guardrails to be implemented in conjunction with a comprehensive budget tracking system. The user of the budget tracking system may define one or more spending guardrails (i.e., spending thresholds) within one or more budget categories having one or more associated guardrail actions that occur when a budget guardrail is achieved. The user may set the guardrail at any desirable spending threshold, such as at the allocated target budget limit for a given budget category or below or above the allocated target budget limit. The guardrail actions, which may be system defined or user configured, may include, but are not limited to, guardrail alerts and/or guardrail penalties. Guardrail alerts are communications sent to the user to inform them that a guardrail has been met or is approaching being met. Additionally, the user may configure the frequency at which the guardrails are communicated and the communication mechanism used to communicate the guardrails. Guardrail penalties may be self-imposed user penalties, such as an automated charitable contribution, an automated contribution to a designated user savings account or a prohibition or limit on further expenditures in the category associated with the guardrail.

The use of spending guardrails is instrumental in insuring that the user of the budget tracking system adheres to their assigned budget. By providing for dynamically configurable spending thresholds/guardrails the user may define, change, suspend or the like the spending guardrails as dictated by current circumstances. The configurable nature of the guardrails insures that guardrails are tailored to the needs of the individual user.

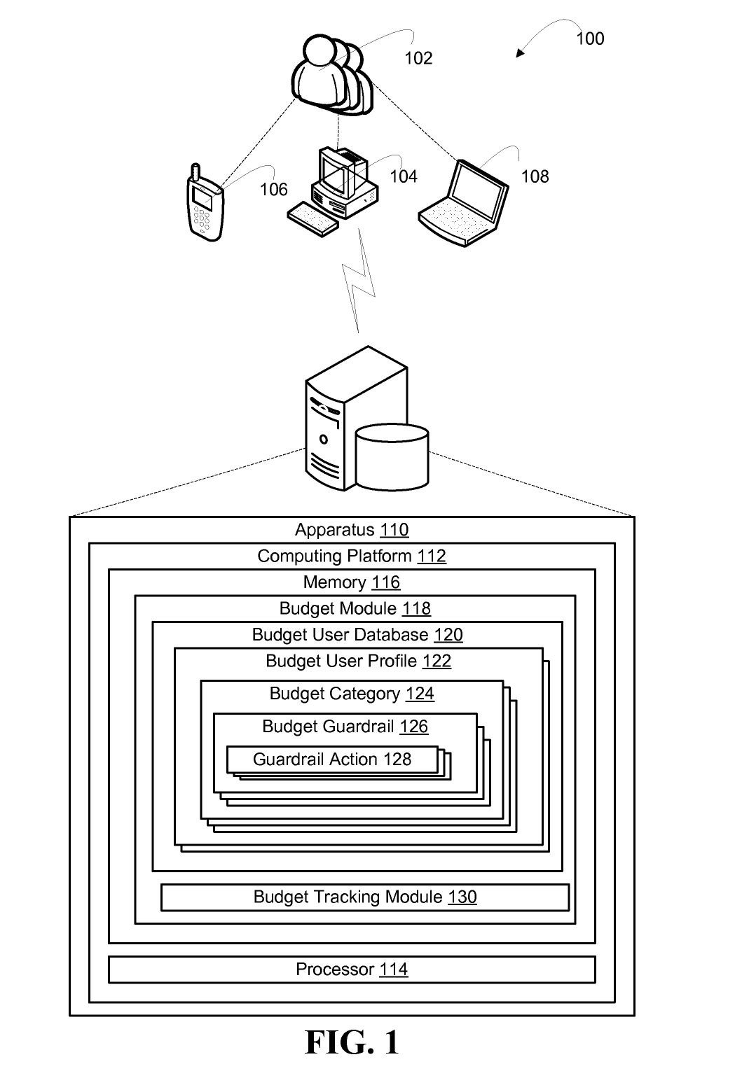

Referring to FIG. 1, a block diagram is depicted of a budget tracking system 100 that provides for a user 102 to access the system wirelessly or otherwise, to track their pre-defined budget from any networked device, such as a PC 104, or a portable device, such as cellular telephone 106 or laptop computer 108. In one embodiment, the budget system 100 may be a web-based system that provides for the user to access budget tracking data from any device providing Internet access.

The budget tracking system 100 also includes an apparatus 110, which may include multiple devices, for executing the budget tracking system 100 and, in particular, an apparatus configured for budget guardrail implementation and tracking, in accordance with an embodiment of the invention. The apparatus 110 includes a computing platform 112 having at least one processor 114 and a memory 116. The memory 116 includes a budget module 118 that is operable to implement a budget tracking system that includes, but is not limited to, user configurable guardrails (i.e., budget thresholds) and actions associated with guardrails.

According to embodiments of the presently described invention, the budget module 118 provides for user configured guardrails and associated guardrail actions. Thus, budget module 118 includes a budget user database 120 that stores a plurality of budget user profiles 122. Each budget user profile 122 may define a plurality of user-defined or budget system defined budget categories 124, such as housing, food, entertainment, transportation and the like. Each budget category 124 may provide for one or more user-defined budget guardrails 126 and each guardrail will have one or more related guardrail actions 128. A guardrail is a user defined spending limit that upon either being met or proximate to being met, depending on system or user configuration, prompts the occurrence of the user-defined or system defined guardrail action. According to one embodiment, the user may configure a budget guardrail 126 at the target budget allocation limit for a predefined category or at any desired spending limit at, below or above the target budget allocation for a given category. The guardrail action may be any suitable system defined or user defined action associated with an occurrence of a guardrail limit/threshold. For example, a guardrail action may be a guardrail alert, a guardrail penalty or the like.

Budget module 118 also includes budget tracking module 130 is operable to track the expenditures made by the customer/user and initiate the defined guardrail action if a user's pre-defined guardrail spending limit has been met or is proximate to being met.

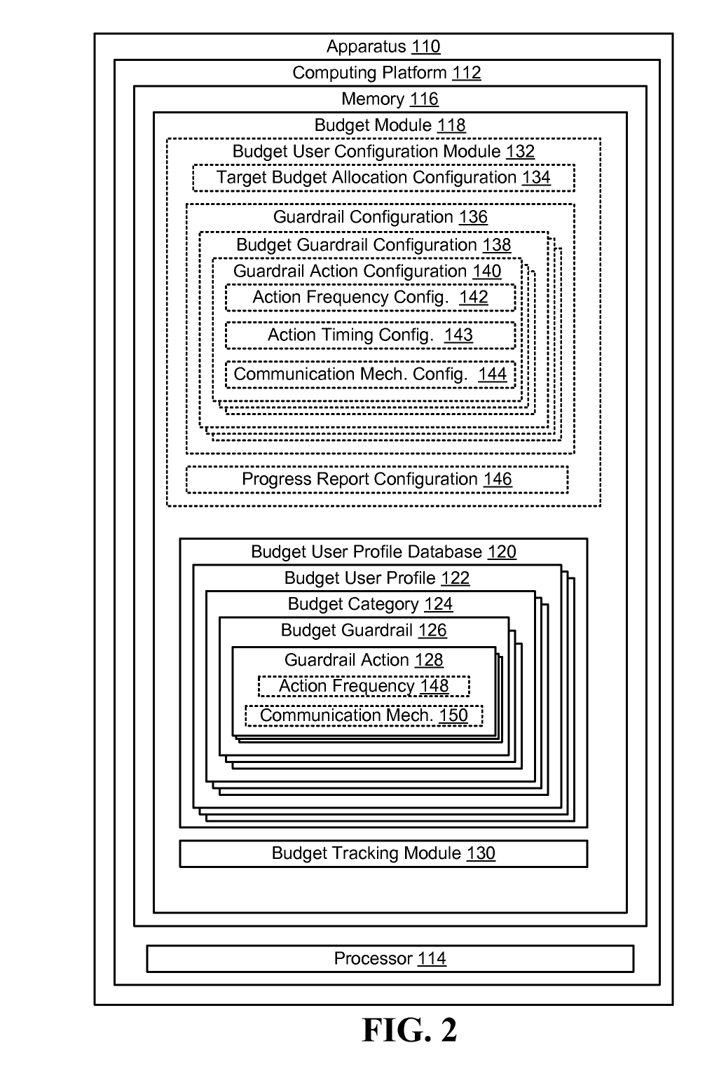

Turning the reader's attention to FIG. 2, a more detailed block diagram of apparatus 110 is depicted that highlights various optional embodiments of the user-configured budget guardrails and associated budget action(s), in accordance with embodiments of the present invention. As previously noted, apparatus 110, which may comprise more than one device, includes a computing platform 112 having a memory 116 and at least one processor 114. The memory 116 stores a budget tracking module 118 that is operable to provide a comprehensive budgeting system for users.

According to certain optional embodiment the budget module 118 may include a budget module user configuration module 132 that provides for the user to configure various aspects of the budget system including target budget allocation, guardrails, associated guardrail action and the like. Thus, budget user configuration module 132 may include target budget allocation configuration 134 that is operable to allow for a user to select, change or otherwise modify the target budget allocations for the plurality of defined budget categories. It should be noted that selection and/or modifications to the target budget allocation may be made at the time of budget tracking system enrollment or the selections and/or modification may occur dynamically on-the-fly based on user need.

Moreover, budget user configuration module 132 may include guardrail configuration 136 operable to provide user's configuration options for guardrails. Guardrail configuration 138 may be operable to provide the user the option of designating guardrails for one or more budget categories. The guardrail, otherwise referred to as the guardrail limit, may be set at the target budget allocation limit for a specified category, or at any other limit below or above the target budget allocation based on the needs of the user. Additionally, guardrail configuration 138 may include guardrail action configuration 140 that is operable to provide the user the ability to define or select one or more actions associated with a defined guardrail. For example, the user may configure a guardrail action as an alert, a penalty, an alert and a penalty or any other possible guardrail action(s). In alternate embodiments, the system may define an action or actions associated with a user-defined guardrail, thus obviating the need for user guardrail action configuration 140.

In addition to defining or selecting guardrail actions, guardrail action configuration 140 may include action frequency configuration 142 operable to provide the user the ability to define the frequency of the action, for example, the frequency for communicating alerts or the like. In addition to frequency configuration 142, guardrail action configuration 140 may provide for action timing configuration 143 that provides the user the ability to configure when the designated action should occur. For example, the user may designate an action to occur when a guardrail has been achieved or when the guardrail sustains achievement for a designated period or when expenditures are approaching a guardrail by a designated range. If the user designates that the action occurs when expenditures are within a predefined range of the guardrail, the guardrail configuration may additionally provide for the acceleration of the action, i.e., the rate at which the frequency of the action increases as the user approaches the guardrail limit.

Additionally, guardrail action configuration 140 may provide for communication mechanism configuration 144 operable to provide the user the ability to define which communication mechanism(s), such as email, SMS/text, online presentation, voice mail or the like, is to be used for a designated action, for example, communicating an alert. In one embodiment of the invention, the alert may be communicated to any device having the ability to receive wireless communication, such as any hand-held device, for example, cellular telephone or a credit card equipped with a wireless receiver. In one embodiment the user may configure the communication mechanism, such that an initial communication/alert is sent via a first communication mechanism and subsequent communications/alerts are sent by a second communication mechanism.

The budget user configuration module may also provide for progress report configuration 146 that provides the user the ability to configure the frequency of communicating budget progress reports to the user and the communication mechanisms for sending such budget progress reports. The budget progress reports provide for a current snapshot of how the user is tracking based on target budget allocation for the short-term and for the long-term.

Thus, as shown in FIG. 2 and previously discussed in relation to FIG. 1, budget user database 120 may store a plurality of budget user profiles 122. Each budget user profile 122 may define a plurality of user-defined or budget system defined budget categories 124, such as housing, food, entertainment, transportation and the like. Each budget category 124 may provide for one or more user-defined budget guardrails 126 and each guardrail will have one or more related user-defined or system defined guardrail actions 128. Additionally, guardrail action 124 may define other user-configured or system defined parameters, such as action frequency 148, communication mechanism(s) 150 or the like.

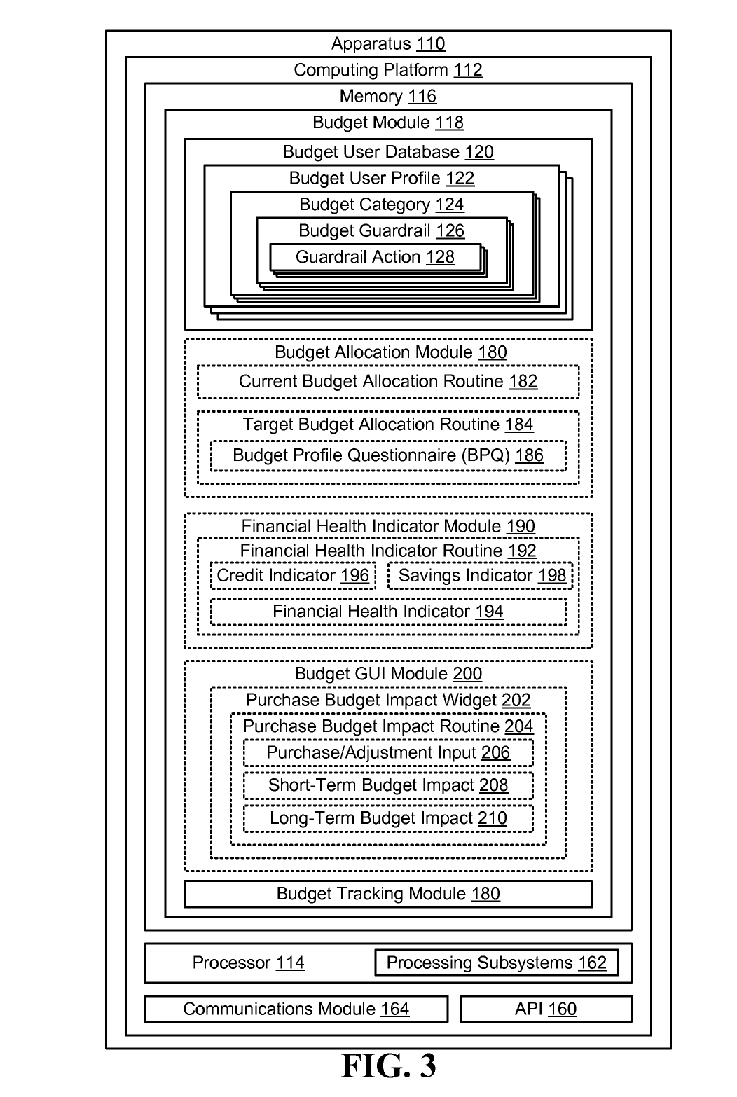

Referring to FIG. 3, a more detailed block diagram is depicted of apparatus 110 that highlights various additional aspects of the budget system 100 herein disclosed. The apparatus 110 may include any type of one or more computerized, communication devices, such as a server, a personal computer, a portable computer, or any device or devices that include a computing platform and have a wired and/or wireless connection to a network or the Internet.

The apparatus 110 includes computing platform 112 that can transmit data across a network, and that can receive and execute routines and applications. Computing platform 112 includes memory 116, which may comprise volatile and non-volatile memory such as read-only and/or random-access memory (RAM and ROM), EPROM, EEPROM, flash cards, or any memory common to computing platforms. Further, memory 116 may include one or more flash memory cells, or may be any secondary or tertiary storage device, such as magnetic media, optical media, tape, or soft or hard disk.

Further, computing platform 112 also includes processor 114, which may be an application-specific integrated circuit (“ASIC”), or other chipset, processor, logic circuit, or other data processing device. Processor 114 or other processor such as ASIC may execute an application programming interface (“API”) 160 that interfaces with any resident programs, such as budget module 118 stored in the memory 116 of the apparatus 110.

Processor 114 includes various processing subsystems 162 embodied in hardware, firmware, software, and combinations thereof, that enable the functionality of apparatus 110 and the operability of the apparatus 110 on a network. For example, processing subsystems 162 allow for initiating and maintaining communications, and exchanging data, with other networked devices. For the disclosed embodiments, processing subsystems 162 of processor 114 may include any subsystem used in conjunction with budget module 118.

Computing platform 112 additionally includes communications module 164 embodied in hardware, firmware, software, and combinations thereof, that enables communications among the various components of the apparatus 110, as well as between the apparatus 110 and an external network, such as the Internet or the like. In described embodiments, the communication module 164 enables the communication of all correspondence between apparatus 110 and other computing devices, such as customer/user devices, 104, 106 and 108 (shown in FIG. 1).

As previously noted and discussed, the memory 116 of computing platform 112 includes budget user database 120 that may store a plurality of budget user profiles 122. Each budget user profile 122 may define a plurality of user-defined or budget system defined budget categories 124, such as housing, food, entertainment, transportation and the like. Each budget category 124 may provide for one or more user-defined budget guardrails 126 and each guardrail will have one or more related guardrail actions 128. In this regard, a guardrail is a customer/user defined spending limit that upon either being met or proximate to being met, depending on system or user configuration, prompts the occurrence of the customer/user defined guardrail action. As such budget tracking module 180 is operable to track the expenditures made by the customer/user and initiate the defined guardrail action if a customer's/user's pre-defined guardrail spending limit has been met or is proximate to being met.

The budget system module 118 may also provide for budget allocation module 180 that is operable to provide for determining a target budget allocation for a financial institution customer based on current budget allocation and user responses to a budget profile questionnaire (BPQ) 186 or allowing a user to select a target budget based on peer data recommendations. As such, budget allocation module 180 includes a current budget allocation routine 182 operable to provide for the user's current budget allocation and a target budget allocation routine 184 that is operable to provide for the target budget allocation based on the current budget allocation and user responses to the BPQ 186.

Other embodiments of the budget module 118 may provide for a financial health indicator module 190 that is operable to dynamically determine and provide to the customer/user an indicator of a user's financial health. In this regard, the financial health indicator module 190 may include a financial health indicator routine 192 that is operable to determine a financial health indicator 194 of the user's financial health based on a credit indicator 196 and a budget indicator 198. The credit indicator 196 may be one or more credit scores as provided by a credit reporting bureau. A financial institution implementing the budget system of the present invention generally has access to a customer's credit score(s). According to one embodiment, the financial health indicator routine 192 may dynamically track the user's credit scores to provide for a credit indicator/score. The budget indicator 198 may be determined based on budget tracking accomplished via budget tracking module 180. By constantly tracking a budget indicator 198 and a credit indicator 196, the resulting financial health indicator 194 is a dynamic indicator that accurately reflects the financial health of the user at any point in time. The financial health indicator 194 may be in a form that indicates the user's financial health, such as, but not limited to, a numerical score, an alphabetic grade, a color on a color scale or the like.

The financial health indicator 194 may be communicated or otherwise provided to the customer/user based on budget system configuration and/or customer/user configuration. In one embodiment the financial health indicator 194 may be provided as a widget running on a dashboard-type application, such that the financial health indicator 194 is dynamically accessible to the customer/user from any networked device, such as a personal computer, laptop computer or a hand-held device, such as a cellular telephone device or the like.

According to still further embodiments, the budget module 118 may include a budget Graphical User Interface (GUI) module 200 operable to provide the customer/user a displayable interface communicated via a network and operable for receiving and inputting budget tracking related information. The budget GUI module 200 may include a purchase budget impact widget 202 that is operable to provide for determination of the budget impact of an actual purchase, considered purchase, an adjustment to an ongoing purchase. The widget may be displayed to the user via a dashboard-type application that provides for various other budget-related tools, modules, widgets and the like.

Thus, purchase budget impact widget 202 may include purchase budget impact routine 204 that is operable to determine the budget impact of a purchase, considered purchase or an adjustment to an ongoing purchase, rental, etc. Thus the purchase budget impact widget 202 may include a purchase/adjustment input 206 operable to receive a customer/user input of a purchase amount, considered purchase amount or adjustment amount. Thus, if the widget is accessible to the user via a hand-held device, such as a cellular telephone or the like, the user can engage the purchase budget impact widget 202 and input an amount at any point in time, such as just prior to making a purchase to determine the budget impact of the purchase. As such, the budget impact determiner aspect of the invention provides for the customer/user to make informed purchasing decisions and hopefully limits the amount of impulsive purchases.

The purchase budget impact routine 204 may be configured to determine a short-term budget impact 208 and/or a long-term budget impact 210 for the inputted amount. A short-term budget impact 208 may be, for example, a month, a portion of a month, a portion of a year or the like. The long-term budget impact 210 may be, for example, periods greater than a year or the like. In alternate embodiments of the invention, the purchase budget impact widget 202 may include logic (not shown in FIG. 3) operable to determine recurring purchases for the customer/user and to automatically activate the widget and provide the customer/user with the budget impact for the recurring purchase, for example, if the customer/user was to forego or limit the number of recurring purchases. In one example, the logic would determine that the customer/user makes a daily or frequent purchase of coffee at a particular coffee shop, based on the identification of this recurring purchase, the widget may be automatically activated and presented to the customer/user to display the short-term and/or long-term budget impact of foregoing the recurring purchase or otherwise limiting the number of the recurring purchases.

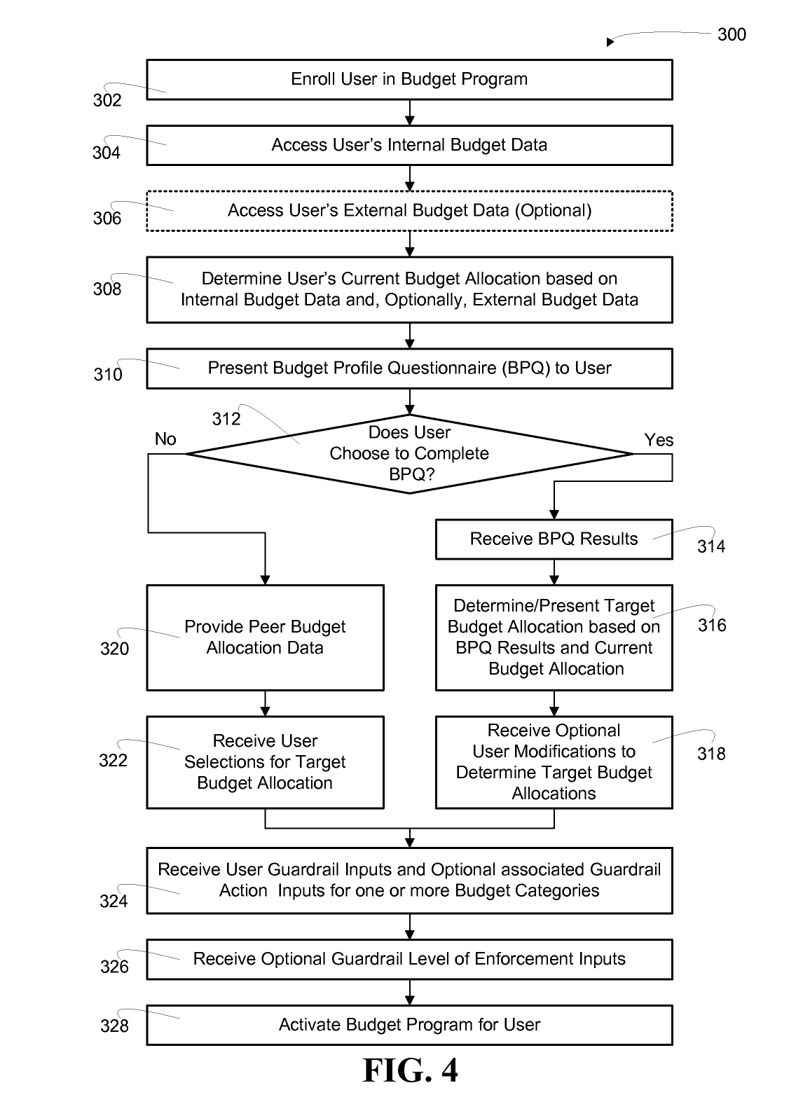

Referring to FIG. 4, a flow diagram is presented of a method 300 for determining a user's target budget allocation and defining guardrails, in accordance with present embodiments of the invention. At Event 302 the user enrolls in a budget program. In one example, the budget system may be implemented by a financial institution. In such embodiments, the user may be a pre-existing financial institution customer, and, in some embodiments, being a financial institution customer may be a pre-requisite to being afforded enrollment in the budget program. According to embodiments of the invention, enrollment, configuration of the user budget criteria and budget tracking information may be provided to the user via a network interface, such as an online website or the like. In one specific embodiment, in which the budget system is implemented by a financial institution, the configuration of the user budget criteria and/or budget tracking information may be accessible online via the financial institution's online banking site.

At Event 304, once the user has enrolled in the budget system, the budget system accesses internal databases, for example, financial institution customer portfolio databases, to retrieve budget-related information from the user's portfolio, such as account information and the like. The budget-related information may include customer transaction data, such as transaction receipts for electronic purchases, such as debit or credit purchases.

At optional Event 306, the budget system may access external databases, such as other financial institution databases, credit card company databases or the like, in an attempt to retrieve other budget-related information associated with the customer/user. By accessing, retrieving and subsequently using external data to determine the current budget information, the current budget allocations are generally more accurate and robust. Additionally, in embodiments in which the budget system is implemented by a financial institution, external data may be necessary in instances in which the user is a new customer or in instances in which the internal database information is not sufficient to provide an accurate depiction of the user's current budget allocation.

At Event 308, the user's current budget allocation is determined based on the internal budget-related data and, optionally, the external budget-related data. The current budget allocation breaks down current expenditures on a per category basis: for example, 30% housing, 10% fuel, 5% entertainment, 15% savings and the like.

At Event 310, the customer is presented with a Budget Profile Questionnaire (BPQ) that includes a plurality of budget-related questions. Specifically, one or more questions are related to the customer's current spending habits and one or more questions are related to determining the latent flexibility in the customer's current budget. At Decision 312, a determination is made as to whether the customer/user chooses to complete the BPQ.

If the customer/user chooses to complete the BPQ, at Event 314, BPQ results are received. The results may be weighted based on budget significance and subsequently scored to result in a BPQ score. At Event 316, a target budget allocation is determined based on the BPQ results or BPQ score and the current budget allocation, and subsequently presented to the user. Similar to the current budget allocation, the target budget allocation breaks down target expenditures on a per category basis. At Event 318, the user may modify the determined target budget allocations to meet their perceived needs.

If the user chooses not to complete the BPQ, at Event 320, peer budget allocation may be presented to the user as a guideline for selecting target budget allocation. The peer data may reflect national averages having or not having similar demographics as the user, financial institution customers or another budget system implementer having or not having similar demographics as the user, individuals residing proximate the user or the like. At Event 322, user budget allocation selections are received by the user, which serve to define the user's target budget allocation.

At optional Event 324, user guardrail inputs and, in some embodiments, associated guardrail action inputs are received for one or more of the categories in the target budget allocation. As previously noted the guardrail defines an expenditure limit at which the associated guardrail action may occur. In accordance with embodiments of the invention, the guardrail may be set at, below or above the target budget allocation for the category. The guardrail action may be pre-defined by the budget system or, in other embodiments, the user may be able to choose and configure the guardrail actions associated with a guardrail. The guardrail action may include, but is not limited to, a guardrail alert and/or a guardrail penalty or the like.

At optional Event 326, one or more user configurable guardrail parameters are received. The guardrail parameters may affect the guardrail limit and/or the guardrail action. For example, the guardrail may define a parameter that defines when the associated action should occur, for example, when the guardrail is met/exceeded or when expenditures are within a predetermined guardrail range. The guardrail action parameters are generally guardrail action specific. For example, if the guardrail action is a guardrail alert, a guardrail parameter may further define a user chosen communication mechanism, and/or a guardrail parameter may define a user selected frequency for communicating the alert once the guardrail has been met, or once the expenditures are within the predetermined guardrail range. If the guardrail action is a guardrail penalty, the guardrail parameter may define the type and/or amount of the penalty. For example, the guardrail penalty may be a contribution to a specified customer account or a contribution to a designated charity. Alternatively, the guardrail penalty may define further spending limitations for the category of interest, or a spending prohibition for the category of interest.

At Event 328, once the target budget has been determined or selected and any optional guardrails are set, the budget program is activated for the user and begins tracking expenditures as they pertain to the target budget allocations, tracking expenditures as they pertain to the guardrails and initiating the guardrail action if a guardrail is met, or if expenditures are within the predefined guardrail range.

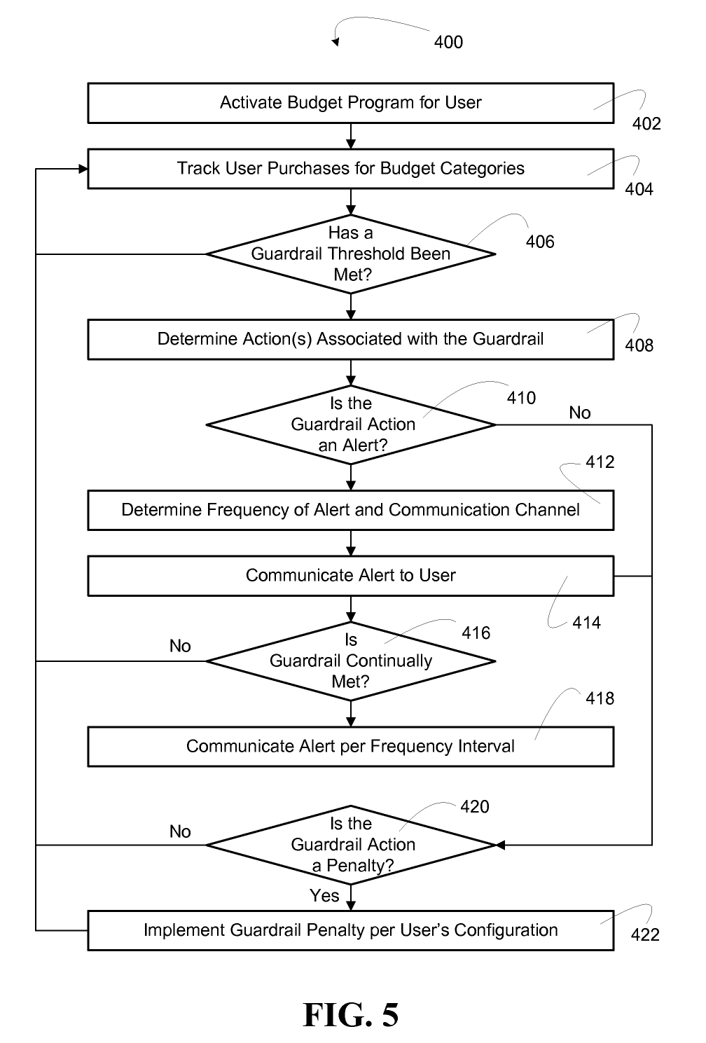

Referring to FIG. 5, a method 400 is provided for tracking guardrails and implementing the action associated with a guardrail in the event the guardrail is achieved, in accordance with embodiments of the present invention. At Event 402, the budget tracking program is activated for a specified user. As described in the flow diagram of FIG. 4, activation of the user is preceded by determination and/or selection of a target budget allocation and selection of guardrails and actions associated with the guardrails. At Event 404, the user's purchases and/or expenditures are tracked for budgeting purposes and applied to the plurality of budget categories.

At Decision 406, a determination is made as to whether a guardrail has been achieved or, if so configured, whether expenditures are within a specified predetermined range of a guardrail that prompts a guardrail action. If the guardrail has not been achieved or otherwise met, the flow returns to Event 402 for further tracking of user's purchases and expenditures. If a guardrail has been determined to be met, then at Event 408, the action or actions associated with the guardrail are determined.

At Decision 410, a determination is made as to whether the guardrail action is an alert. If the guardrail action is determined to be an alert, then at Event 412, the frequency of the alert is determined and the communication channel for the alert is determined. The frequency of the alert and/or the communication channel for the alert may be user-configured or configured within the budget system. Frequency of the alert pertains to how frequently the alert will be communicated to the user during the current budget period, for example, during the current month, once the guardrail has been achieved, or once expenditures are within the predetermined range for prompting guardrail action. The communication channel may be an online communication, email communication, SMS/text communication, voice mail communication or the like. In one embodiment of the invention, the user may configure the budget system to communicate the alert via more than one communication channel. At Event 414, the alert is communicated to the user via the designated communication channel.

At Decision 416, a determination is made as to whether the guardrail threshold is continually being achieved. In some instances, it may be possible to achieve a guardrail for a specified budget period and subsequently fall below the guardrail, for example, if negative expenditures occur in the category in which the guardrail was achieved. If the guardrail is no longer being achieved, then the flow returns to Event 404 for further tracking of user expenditures. If the guardrail continues to be achieved (i.e., the guardrail threshold is met), then at Event 418, the alert is communicated to the user at the predefined frequency interval.

If a determination is made that the guardrail action is or is not an alert, at Decision 420, a determination is made as to whether the guardrail action is a penalty. It should be noted that while the flow diagram of FIG. 5 is limited to guardrail actions being alerts and/or penalties, it is possible and within the confines of the present invention for the guardrail action to be any other action aside from an alert or penalty. As previously noted the penalty may come in the form of a contribution to a user's financial institution account, such as a savings account, an IRA or the like, a contribution to a designated charity, or a prohibition or limitation of further spending in the category associated with the guardrail. If the guardrail action is determined to be a penalty then, at Event 422, the penalty is implemented per the user's configuration as to the type of penalty and the amount or severity of the penalty. If the guardrail action is determined to not be a penalty, the flow returns to Event 404 for further tracking of the user's expenditures.

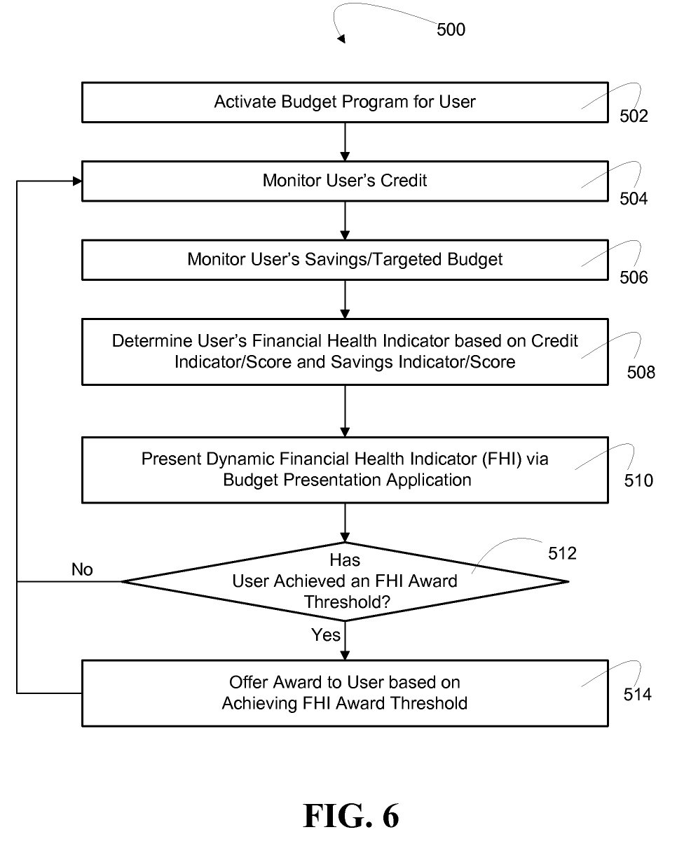

Turning the reader's attention to FIG. 6, a method 500 is detailed for determining a financial health indicator for a user of an associated budget system, in accordance with an embodiment of the present invention. At Event 502, the budget system is activated for a user. Activation is typically preceded by determining or selecting a target budget allocation and, optionally, defining guardrails and associated guardrail actions for one or more target budget allocation categories.

At Event 504, the user's credit is dynamically monitored or otherwise tracked. Credit monitoring may include monitoring a user's credit score as provided by one or more credit reporting bureaus. In one embodiment of the present invention, a plurality of user credit scores are monitored from different credit reporting bureaus, subsequently weighted to allow for a difference in the score and averaged to determine a collective credit score for the budget user.

At Event 506, the user's savings (i.e., the user's ability to stay on budget) is dynamically monitored or otherwise tracked. The user's savings indicator may be based on short-term savings or long-term savings, or any combination of both. The savings indicator may provide for an overall savings score or the like.

At Event 508, a financial health indicator is determined for the user based on the credit indicator/score and the savings indicator/score. It should be noted that the financial health indicator may be based on factors other than the credit indicator/score and the savings indicator/score. In one specific embodiment, the financial health indicator is based on a ratio of about 70% credit indicator/score and about 30% savings indicator/score. The financial health indicator may be a numeric score, an alphabetic grade, a color on a color scale or the like.

At Event 510, the dynamic financial health indicator is presented to the user via a budget presentation (i.e., Graphical User Interface (GUI)) application. According to one embodiment, the financial health indicator may be presented to the user online via a budget system portal or the like. In other embodiments, the financial health indicator may be provided via a widget that runs on a dashboard-type budget application, As such, the financial health indicator may be provided to the user via any wired and/or wireless networked device, including, but not limited to, a PC, a laptop, a hand-held device, such as a cellular telephone or the like. The dynamic nature of the financial health indicator means that the indicator may fluctuate in real-time or near-real-time based on current expenditures made by the user.

At optional Decision 512, if the financial health indicator is associated with a rewards program, a determination may be continually made to determine if the user's financial health indicator has risen to a level (i.e., met a threshold or sustained a threshold for a predetermined period of time) to warrant a reward. Rewards may include, but are not limited to, better rates of return on a financial institution account, better pricing on financial institution services and/or products, a reward gift or the like. If a determination is made that the financial health indicator has risen to a reward level, at Event 514, the reward is automatically provided to or offered to the user or a determination is automatically triggered to determine if the user otherwise qualifies for the designated reward. If a determination is made that the financial health indicator has not risen to the reward level, the process returns to Event 504 for further tracking of the credit indicator/score and savings indicator/score, and dynamic determination of the financial health indicator based on the tracked credit indicator/score and savings indicator/score.

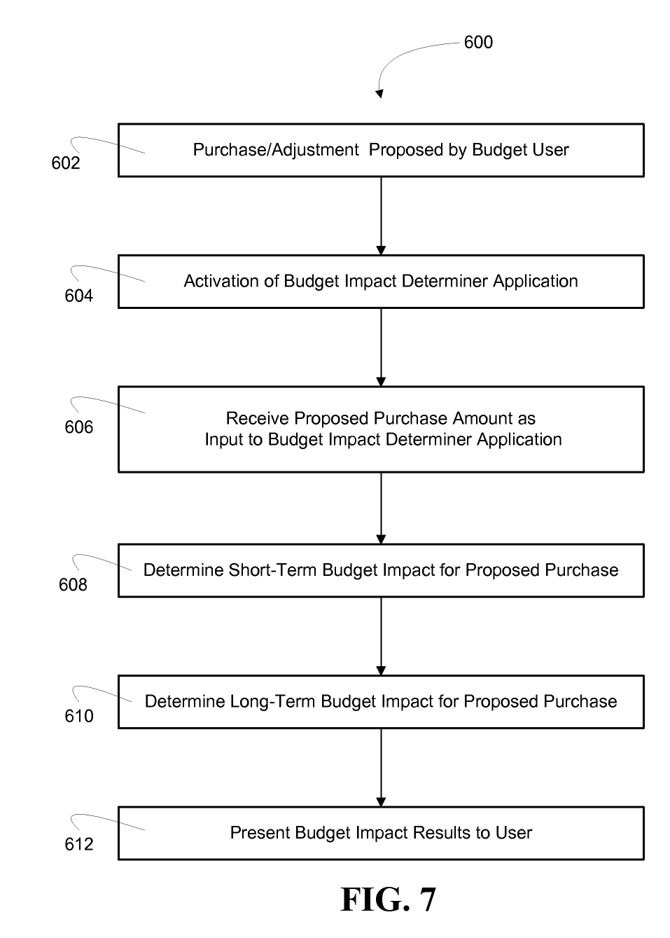

Referring to FIG. 7 a flow diagram is depicted of a method 600 for budget impact determination, in accordance with an embodiment of the present invention. At Event 602, the budget system user is presented with a proposed expenditure or an adjustment to a pre-existing expenditure, such as a change in a mortgage payment or the like. At Event 604, based on the proposed expenditure, the user activates a budget impact determiner application. It should be noted that while the illustrated flow requires an expenditure or expenditure adjustment to be proposed or otherwise contemplated by the budget user, in practice and within the context of the invention, the budget impact determiner application can be accessed at any point in time by the user, prior to an expenditure or after an expenditure has been undertaken. In one embodiment of the invention, the budget impact determiner application is accessible via the user's hand-held device, such as a cellular telephone; as such, the user may access the application at a point-of-sale, such as a retail outlet, prior to making a purchase to assess the budgetary impact of the purchase.

At Event 606, the proposed expenditure amount or expenditure adjustment is inputted into the budget impact determiner application. It should be noted that one alternate embodiment of the application provides for the application to logically determine recurring expenditures, which, once determined, provide for the automatic launch of the budget impact determiner application and the automatic input of the recurring expenditure amount, such that the application automatically determines the budget impact of the recurring purchase and presents the results to the user.

At Event 608, the application determines the short-term budget impact of the expenditure. The short-term budget impact may be any short-term period as defined by the user or the system. For example, the short-term period may be a month, a portion of the month, a year or a portion of the year. At Event 610, the application determines the long-term budget impact of the expenditure. The long-term budget impact may be any long-term period as defined by the user or the system. For example, the long-term period may be a year, or any period greater than a year. At Event 612, the results of the budget impact determination are presented to the user or otherwise communicated to the user.

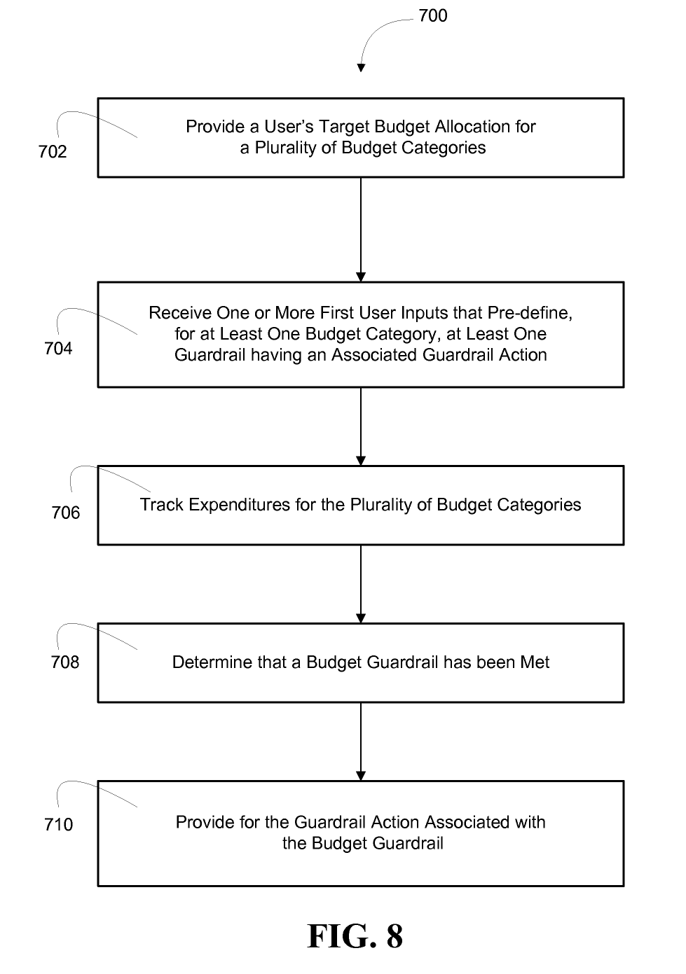

Referring to FIG. 8, a flow diagram is provided of a method 700 for providing for and tracking guardrails in budget tracking system, in accordance with an embodiment of the present invention. At Event 702, a budget system user's target budget allocation is provided for a plurality of budget categories. According to one embodiment the target budget allocation may be provided by determining a current budget allocation based a user's internal budget-related data and/or based on data mined from external sources. In such embodiments, the target budget allocation is determined based on the current budget allocation and user responses to a Budget Profile Questionnaire (BPQ) that includes a plurality of budget profile questions.

At Event 704 one or more user inputs are received that pre-defines, for at least one budget category, at least one guardrail having an associated guardrail action. According to embodiment of the invention, one or more second users inputs are received that pre-define the associated guardrail action and/or parameters related to the guardrail action such as frequency of an action or the communication mechanism for an action. In one embodiment the guardrail action may be a guardrail alert, a guardrail penalty, both a guardrail alert and a guardrail penalty or the like.

At Event 706, user expenditures are tracked. Electronic payments, such as credit/debit purchases or the like, may be automatically tracked for budgetary purposes, while manual payments, such as cash payment or the like, may be manually tracked based on user input of payment amount.

At Event 708, the budget system determines that a budget guardrail has been achieved. Achieving a guardrail may include meeting the predefined user configured guardrail limit or expenditures in the range of a pre-determined guardrail.

At Event 710, the guardrail action or actions associated with the guardrail are provided based on the guardrail being achieved. In one embodiment, this may entail communicating a guardrail alert to the user, while in another embodiment, providing the guardrail action may include providing for a guardrail penalty, such as an account contribution, a charitable contribution, a prohibition or limit on spending in the guardrail category or the like.

Thus, methods, systems, computer program products and the like provide for user-configured spending guardrails in a budget tracking system. The use of spending guardrails is instrumental in insuring that the user of the budget tracking system adheres to their assigned budget. By providing for dynamically configurable spending thresholds the user may define, change, suspend or the like spending guardrails as dictated by current circumstances. The configurable nature of the guardrails insures that guardrails are tailored to the needs of the individual user.

While the foregoing disclosure discusses illustrative embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any embodiment may be utilized with all or a portion of any other embodiment, unless stated otherwise.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A method for providing guardrail protection in a budget tracking system, the method comprising:
providing a target budget allocation for a plurality of budget categories;
receiving one or more first user inputs that predefine, for at least one budget category, at least one budget guardrail having at least one associated budget guardrail action;
tracking expenditures for the plurality of budget categories;
determining that a budget guardrail has been met; and
providing for the budget guardrail action associated with the budget guardrail.

2. The method of claim 1, wherein receiving one or more user inputs that predefine at least one budget guardrail having at least one associated budget guardrail action further defines the budget guardrail as a budget threshold at, below or above the target budget allocation for the associated budget category.

3. The method of claim 1, wherein providing for the budget guardrail action associated with the budget guardrail further comprises providing for the budget guardrail action associated with the budget guardrail based on the determination that the budget guardrail has been met.

4. The method of claim 1, further comprising determining that a budget guardrail is approaching being met.

5. The method of claim 4, wherein providing for the budget guardrail action associated with the budget guardrail further comprises providing for the budget guardrail action associated with the budget guardrail based on determination that a budget guardrail is approaching being met.

6. The method of claim 1, wherein receiving one or more user inputs that predefine at least one budget guardrail having at least one associated budget guardrail action further receiving one or more second user inputs that predefine the at least one associated budget guardrail.

7. The method of claim 1, wherein receiving one or more user inputs that predefine at least one budget guardrail having at least one associated budget guardrail action further defines the budget guardrail action as a guardrail alert.

8. The method of claim 7, further comprising receiving one or more second user inputs that predefine a communication mechanism for the guardrail alert.

9. The method of claim 8, wherein receiving one or more second user inputs that predefine a communication mechanism for the alert further defines the communication mechanism as chosen from electronic mail (e-mail), Short Message Service (SMS), voice mail or an online budget application display.

10. The method of claim 1, further comprising receiving one or more second user inputs that predefine a frequency for the guardrail alert.

11. The method of claim 1, wherein receiving one or more user inputs that predefine at least one budget guardrail having at least one associated budget guardrail action further defines the budget guardrail action as a budget penalty.

12. The method of claim 11, wherein receiving one or more user inputs that predefine at least one budget guardrail having at least one associated budget penalty further defines the penalty as chosen from an automatic charitable contribution, an automatic savings contribution, a limit on an amount of an expenditure in the associated budget category or a prohibition on an expenditure in the associated budget category.

13. The method of claim 1, wherein providing a target budget allocation for a plurality of budget categories further comprises determining a target budget allocation for the plurality of budget categories based on a current budget allocation and results of user-responsive budget profile questionnaire.

14. The method of claim 13, wherein providing a target budget allocation for a plurality of budget categories further comprises receiving one or more user modifications to the determined target budget allocation.

15. The method of claim 1, wherein providing a target budget allocation for a plurality of budget categories further comprises determining peer budget allocation data based on a user's profile, providing the peer budget allocation data to the user and receiving user selections for the target budget allocation based on the peer budget allocation data.

16. The method of claim 1, wherein tracking expenditures for the plurality of budget categories further comprises tracking, automatically, electronic expenditures based on a purchase type associated with a budget category and tracking, manually, based on user purchasing inputs to an online budget application.

17. An apparatus for, the apparatus comprising:
a computing platform including at least one processor and a memory; and
a budget module stored in the memory, executable by the processor and operable to track expenditures for users, wherein the budget module comprises:
a budget user profile database that includes a plurality of budget user profiles, each profile including a plurality of budget categories, wherein one or more of the budget categories include at least one user-configured budget guardrails and each guardrail includes at least one budget guardrail actions, and
a budget tracking module operable to track expenditures for the plurality of budget categories, determine that a budget guardrail has been met and provide for the budget guardrail action associated with the budget guardrail.

18. The apparatus of claim 17, wherein the budget guardrail is further defined as a budget threshold set at, below or above a target budget allocation for an associated budget category.

19. The apparatus of claim 17, wherein the budget tracking module is further operable to provide for the budget guardrail action associated with the budget guardrail based on the determination that the budget guardrail has been met.

20. The apparatus of claim 17, wherein the budget tracking module is further operable to determine that a budget guardrail is approaching being met.

21. The apparatus of claim 20, wherein the budget tracking module is further operable to provide for the budget guardrail action associated with the budget guardrail based on determination that a budget guardrail is approaching being met.

22. The apparatus of claim 17, wherein the budget guardrail action is further defined as a guardrail alert.

23. The apparatus of claim 22, wherein each guardrail alert further comprises a user-configured communication mechanism for communicating the guardrail alert.

24. The apparatus of claim 23, wherein the user configured-communication mechanism further comprises a communication mechanism chosen from electronic mail (e-mail), Short Message Service (SMS), voice mail or an online budget application display.

25. The apparatus of claim 17, further each guardrail alert further comprises a user-configured frequency for communicating the guardrail alert.

26. The apparatus of claim 17, wherein the budget guardrail action is further defined as a budget penalty.

27. The apparatus of claim 26, wherein the budget penalty is further defined as a budget penalty chosen from an automatic charitable contribution, an automatic savings contribution, a limit on an amount of an expenditure in the associated budget category or a prohibition on electronic expenditures in the associated budget category.

28. The apparatus of claim 17, wherein the budget tracking module is further operable to track, automatically, electronic expenditures based on a purchase type associated with a budget category and track, manually, based on user purchasing inputs to an online budget application.

29. A computer program product comprising:
a computer-readable medium comprising:
a first set of codes for causing a computer to provide a target budget allocation for a plurality of budget categories;
a second set of codes for a causing a computer to receive one or more first user inputs that predefine, for at least one budget category, at least one budget guardrail having at least one associated budget guardrail action;
a third set of codes for causing a computer to track expenditures for the plurality of budget categories;
a fourth set of codes for causing a computer to determine that a budget guardrail has been met; and
a fifth set of codes for causing a computer to provide for the budget guardrail action associated with the budget guardrail.

30. The computer program product of claim 29, wherein the second set of codes is further operable to cause the computer to receive one or more user inputs that predefine at least one budget guardrail defined as a budget threshold at or below the target budget allocation for the associated budget category.

31. The computer program product of claim 29, wherein the fifth set of codes is further operable to cause the computer to provide for the budget guardrail action associated with the budget guardrail based on the determination that the budget guardrail has been met.

32. The computer program product of claim 29, further comprising a sixth set of codes for causing a computer to determine that a budget guardrail is approaching being met.

33. The computer program product of claim 32, wherein the fifth set of codes is further operable to cause the computer to provide for the budget guardrail action associated with the budget guardrail based on determination that a budget guardrail is approaching being met.

34. The computer program product of claim 29, wherein the second set of codes is further operable to cause the computer to receive one or more user inputs that predefine at least one budget guardrail having at least one associated budget guardrail action further defined as a guardrail alert.

35. The computer program product of claim 34, further comprising a sixth set of codes for causing a computer to receive one or more second user inputs that predefine a communication mechanism for the guardrail alert.

36. The computer program product of claim 35, wherein the sixth set of codes is further operable to cause the computer to receive one or more second user inputs that predefine a communication mechanism for the alert, wherein the communication mechanism is one of electronic mail (e-mail), Short Message Service (SMS), voice mail or an online budget application display.

37. The computer program product of claim 29, further comprising a sixth set of codes for causing a computer to receive one or more second user inputs that predefine a frequency for the guardrail alert.

38. The computer program product of claim 29, wherein the second set of codes is further operable to cause the computer to receive one or more user inputs that predefine at least one budget guardrail having at least one associated budget guardrail action defined as a budget penalty.

39. The computer program product of claim 38, wherein the second set of codes is further operable to cause the computer receiving one or more user inputs that predefine at least one budget guardrail and at least one associated budget penalty further defined as one of an automatic charitable contribution, an automatic savings contribution, a limit on an amount of an expenditure in the associated budget category or a prohibition on an expenditure in the associated budget category.

40. The computer program product of claim 29, wherein the first set of codes is further operable to cause the computer to determine a target budget allocation for the plurality of budget categories based on a current budget allocation and results of user-responsive budget profile questionnaire.

41. The computer program product of claim 39, wherein the first set of codes is further operable to cause the computer to receive one or more user modifications to the determined target budget allocation.

42. The computer program product of claim 29, wherein the first set of codes is further operable to cause the computer to determine peer budget allocation data based on a user's profile, providing the peer budget allocation data to the user and receiving user selections for the target budget allocation based on the peer budget allocation data.

43. The computer program product of claim 29, wherein the third set of codes is further operable to cause the computer to track, automatically, electronic expenditures based on a purchase type associated with a budget category and track, manually, based on user purchasing inputs to an online budget application.
